(19) United States
(12) Patent Application Publication
(10) Pub. No.: US 2025/0232254 A1
(43) Pub. Date: Jul. 17, 2025

(54) INTELLIGENT NETWORK OF WEARABLE MAGNETIC Tx/Rx TAGS FOR AUTONOMOUS LOCAL AND GLOBAL MONITORING AND RESUPPLY OF CONSUMABLE RESOURCES IN MOBILE UNITS

(71) Applicant: Raytheon Company, Tewksbury, MA (US)

(72) Inventors: Christopher R. Fasula, N KINGSTOWN, RI (US); Haxel J Estavillo, HUDSON, MA (US); Gregory K. Toy, Tucson, AZ (US); John A. Cogliandro, Dedham, MA (US); Sarah A. Burke, SOMERVILLE, MA (US); Matthew J. Tacy, Boston, MA (US); Oran D. May, TUCSON, AZ (US)

(21) Appl. No.: 18/410,626

(22) Filed: Jan. 11, 2024

(51) Int. Cl. G06Q 10/087; G06K 7/08

(52) U.S. Cl. CPC G06Q 10/087; G06K 7/087

(57) ABSTRACT

A system for autonomously managing resupply of consumable resources for a mobile unit includes sensors that monitor a level of a consumable resource for each entity in the unit. A network of tags communicates via short-range magnetic communications links. A local node provides a long-range RF communication link to communicate with a global node. Together the network of tags, local node and global node initiate a local resupply of the consumable resource to one or more entities from other entities within the mobile unit and a global resupply of the mobile unit from the one or more depots. The network of sensors/tags automates the task of monitoring resource levels and managing resupply. The use of the magnetic portion of the EM spectrum for local communications within the mobile unit overcomes the issues associated with RF in harsh or hostile environments.

### BACKGROUND

### Field

This disclosure relates to the monitoring and resupply of consumable resources in mobile units such as special forces units, emergency service units, or the like in harsh or hostile environments such as in dense urban areas, industrial facilities or military engagements.

### Description of the Related Art

Mobile units of people e.g., warfighters, fireman, policeman, disaster rescue personnel, industrial operators and possibly machines e.g., robots, drones or the like must function together in close proximity as a coordinated team to execute a mission albeit a military mission, fire, civil unrest, disaster rescue or operation/maintenance/repair in an industrial facility.

These entities will typically use some form of local RF network to communicate within the mobile unit to exchange vital information and replan on the fly. One or more entities within the mobile unit will have access to a longer range RF link via antenna or satellite to communicate with a command center. RF communications resides in a band of frequencies between 30 MHz to 30 GHz.

Often the entities will carry resources such as water, food, batteries or ammunition. These resources may be evenly or unevenly distributed amongst the team. Over the course of the mission these resources are consumed and require resupply. The entities may communicate within the unit to perform a local resupply in which one or more entities will provide resources to another entity. The mobile unit may communicate with the command center to affect a global resupply of the mobile unit.

The environs in which such mobile units operate may be considered “harsh” from the perspective of RF communications. These environments may be dense urban areas or large industrial complexes in which buildings and equipment and particularly the presence of metal walls or objects or high energy emitting machinery or power supplies can often interfere with RF communications. Reliable communications in these harsh environs is critical to mission success and, in particular, to timely and proper resupply of the resources.

Furthermore, in military conflict scenarios, although the RF communications may be encrypted, the RF energy transmitted by individual entities in the mobile unit or to the command center can be easily detected from long distances and used to triangulate the location of the individual entities or the longer range RF transmitter. For example, even low power bluetooth transmissions can be detected and triangulated over 10 miles away. In these conflict scenarios and “hostile” environments, all types of communications including the request and coordination or resupply efforts can expose the entities to a nearly immediate enemy response. Furthermore, in these conflict scenarios, the simple acts of checking ammo supplies, battery power, etc. can distract the warfighter and further expose the warfighter to the enemy.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

The present disclosure provides a system for autonomously managing resupply of consumable resources for a mobile unit operating in a harsh or hostile environment. Entities within the mobile unit are provided with sensors that monitor a level of a consumable resource. A network of communication tags linked to the sensors communicates via short-range low-bandwidth magnetic communications links. A local node provides a long-range high-bandwidth RF communication link to communicate with a global node. Together the network of tags, which contain data from the sensors, the local node and global node initiate a local resupply of the consumable resource to one or more entities from other entities within the mobile unit and a global resupply of the mobile unit from the one or more depots. The network of sensors/tags automates the task of monitoring resource levels and managing resupply. The use of the magnetic portion of the EM spectrum (30 KHz to 900 KHz) for local communications within the mobile unit overcomes the issues presented by the harsh or hostile environments.

In an embodiment, a system for managing resupply of consumable resources for a mobile unit includes a global node including computer processing resources and a high-speed bi-directional RF communications link and a local node including computer processing resources, a long-range high-bandwidth RF communications link (such as a satellite communications or cell phone-based system) to communicate with the global node and a low-speed bi-directional magnetic wireless communications link. The entities in the mobile unit are provided with wearable tags. Each tag includes a sensor communication interface, computer processing resources, and a short-range low-bandwidth magnetic communications link. One or more sensors are associated with each wearable tag and configured to monitor a level of a consumable resource associated with the entity and to communicate the level to the tag's communication interface. A network of the wearable tags and the local node facilitates communicate within the mobile unit using the magnetic communications link. The computer processing resources allocated among the tags, the local node and the global node monitor the levels of the consumable resources of different entities to initiate a local resupply of the consumable resource to one or more entities from other entities within the mobile unit and a global resupply of the mobile unit from one or more remote depots. The local and global resupply efforts may occur one or more times and at different points to execute a mission.

In an embodiment, the RF communications link operates in frequency range of 30 MHz to 30 GHz and the magnetic communications link operates in a frequency range of 30 KHz-900 KHz.

In an embodiment, the system is provided with an initial load out (e.g., the level of consumable resources provided each entity) that is programmed into each tag, into the global node and the global resupply plan at the depot based on the composition of the mobile unit, the mission, the history of resupply requirements of similar units and missions and other factors. This information forms a mission-based baseline. The global resupply plan is updated as resources are consumed and resupplied, and if connection is lost to the local node, the system continues global resupply according to the last updated global resupply plan. The global node is responsive and adjusts to reported levels of consumable resources for each entity within the mobile unit and the unit as a whole, reported health data for each entity and the unit as a whole as well as other situational awareness inputs including but not limited to location information regarding the unit and individual entities, environmental conditions, progress of the mission, changes to the mission and changes to the threat.

In an embodiment, each tag's computer processing resources are configured to condition data from the one or more sensors (to reduce the amount of data to be communicated) and to periodically transmit the level of the consumable resource and to, as warranted, transmit a resupply request. Each tag communicates with the entity to supply messages related to the local or global resupply of the consumable resources of the entity or mobile unit e.g., “request for additional ammo sent”, “request for additional ammo confirmed”, “move to coordinates x,y to receive additional ammo” and the like. Each tag is configured to update the level of the consumable resource upon the completion of the local or global resupply. For example, each consumable resource may be provided with a sensor/tag including a magnetic communications link. The presence or absence of a consumable resource proximate the entity's tag updates the level of the consumable resource. If an entity, and its tag, wanders out-of-range of the network, the network provides an out-of-range message to the entity.

In different embodiments, the local node may be a fixed node that is positioned with the mobile unit but separate from any specific entity. The separation provides a level of safety from targeting when the node transmits via the RF communications link to the node. The local node may be a drone that positions itself within the mobile unit to improve communication among the tags in the network. A designated entity may be provided with a tag that has additional resources (e.g., the RF comm link) to provide the local node. Each tag may include the RF comm link making it capable of being the local node. The network may assign different tags, randomly or according to a pattern, to act as the local node at different times. One or more tags may not include but may be able to access a long-range high-bandwidth RF communications link within the mobile unit to act as the local node.

For example, each entity may have such an RF comm link for audio/video communication. Alternately, each entity may only have the local RF communications link but which provides access to the long-range high-bandwidth RF communications link. The separation of and combination of magnetic and on-demand RF technologies can greatly increase total system performance while maintaining secrecy and safety.

A visual queue system such as red or green or yellow lights corresponding to consumable levels of a resource is optionally added to the system. In this visual embodiment, the entities are provided with a visual cue of their own levels of consumable resources and the consumable resource levels of other unit members on demand or when critical resupply is needed. The cue may be displayed on the entity's tag, electronic arm band or on a heads up display.

In another embodiment one or more wearable sensors are configured to measure health related data. The computer resources allocated among the tags, the local node and the global node monitor the health data to initiate local assistance one or more distressed entities from within the mobile unit and global assistance from an external source. The entities and health related data may be for either humans or machines. In a specific example, the sensor measures a shock level indicative of concussive effects.

These and other features and advantages of the disclosure will be apparent to those skilled in the art from the following detailed description of preferred embodiments, taken together with the accompanying drawings, in which:

### BRIEF DESCRIPTION OF THE DRAWINGS

FIG. 1 is a diagram illustrating the magnetic and RF portions of the electromagnetic (EM) spectrum;

FIG. 2 is a plot of power vs range for magnetic and RF Tx/Rxs;

FIG. 3 is a diagram of a system for managing resupply of consumable resources for a mobile unit;

FIGS. 4A-4D illustrate different embodiments of a magnetic communication tag;

FIGS. 5 and 6 illustrate different embodiments for networking the tags to the local node via magnetic communication links;

FIGS. 7A-7B illustrate a flow diagram for affecting local and global resupply of ammunition to the warfighters in a mobile unit; and

FIGS. 8 and 9A-9C illustrate a warfighter provided with a magnetic communications tag and multiple health sensors and a flow diagram for affecting local and global assistance to the warfighters in a mobile unit.

### DETAILED DESCRIPTION

The present disclosure provides a system for autonomous managing resupply of consumable resources for a mobile unit operating in a harsh or hostile environment. Entities within the mobile unit are provided with sensors that monitor a level of a consumable resource. A network of communication tags linked to the sensors communicates via low-speed bi-directional magnetic communications links. A local node provides a high-speed bi-directional RF communication link to communicate with a global node. Together the network of tags, local node and global node initiate a local resupply of the consumable resource to one or more entities from other entities within the mobile unit and a global resupply of the mobile unit from the one or more depots. The network of sensors/tags automates the task of monitor resource levels and managing resupply.

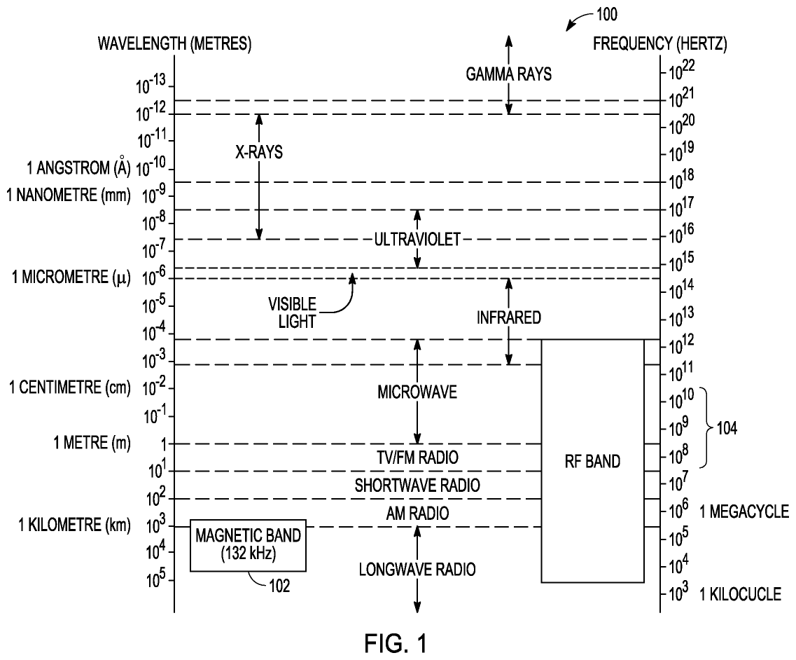

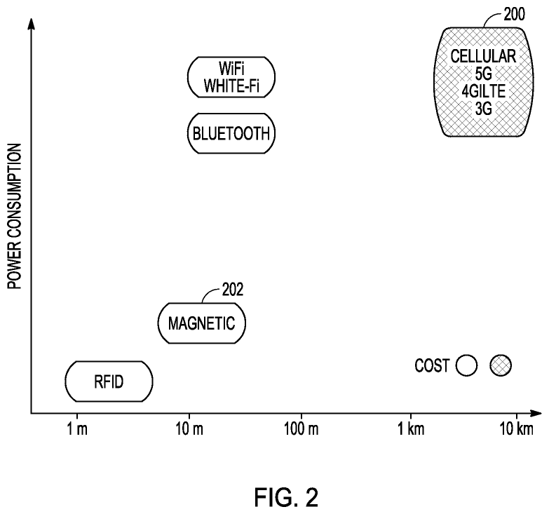

The use of the magnetic portion of the EM spectrum for local communications within the mobile unit overcomes the electronic communication issues typically presented by the harsh or hostile environments, which are particularly challenging for RF (Radio Frequency) based communications. As shown in FIG. 1, a magnetic portion 100 of the EM spectrum 102 generally resides from 30-900 KHz with wavelengths between 10 km to 1 km. By contrast an RF portion 104 resides in 30 MHz to 30 GHz with wavelengths of 10 m to 1 cm. For example, the Iridum satellite phone network, which could be used as the RF communications link, provides L-band communications from 1,618.725 to 1,626.5 MHz. In the magnetic band, the signals easily penetrate through buildings, walls and metal commonly found in “harsh” environments and provides for highly reliable communications. Furthermore, signals in the magnetic band are much harder to detect and detection would only be possible in close proximity to the source. As shown in FIG. 2, RF transceivers (Tx/Rxs) 200 are capable of long range communications over thousands of meters but require high levels of power and are easily detected and triangulated at range, whereas magnetic Tx/Rxs 202 are limited to short range communications generally over 10 s of meters but require very little power and are difficult to detect at range making them ideal for use in wearable technology “tags” for members of mobile units operating in close proximity and in hostile environs.

One example of a suitable bi-directional magnetic communications link is “RuBee” (IEEE Standard 1902.1), which provides a two-way active wireless protocol designed for harsh environments and high-security asset visibility applications. RuBee utilizes longwave signals to send and receive short (128 byte) data packets in a local regional network. Rubee typically operates in a range of 10 feet to about 100 feet using a very small sensor antenna (e.g., 2 inches long×¼ inch diameter). With larger antennas and a bit more power the range can be extended to about 300 feet. The protocol is similar to the IEEE 802 protocols in that RuBee is networked by using on-demand, peer-to-peer, and active radiating transceivers. RuBee is different in that it uses a low frequency (131 kHz) carrier. One result is that RuBee is slow (1,200 baud) compared to other packet-based network data standards (Wi-Fi). 131 kHz as an operating frequency provides RuBee with the advantages of ultra-low power consumption (battery life measured in many years) and normal operation near steel and/or water. These features make it easy to deploy sensors, controls, or even actuators and indicators.

IEEE standard 1902.1 is “physical layer” workgroup. The standard includes such things as packet encoding and addressing specifications. The protocol has already been in commercial use by several companies, in asset visibility systems and networks. However, IEEE 1902.1 will be used in many sensor network applications, requiring this physical layer standard in order to establish interoperability between manufacturers. A second standard has been drafted 1902.2 for higher level data functions required in networks. RuBee has, for example, a 4 bit, 1 to 5 KB of sRAM, crystal, and lithium battery with expected life of five years. It could optionally have sensors, displays, and buttons. RuBee is bidirectional, on-demand, and peer-to-peer. It can operate at other frequencies (e.g. 450 kHz) but 131 kHz is optimal. RuBee tags can have sensors added (temperature, humidity), and optional displays, and may have a full 4-bit microprocessor with static memory. The RuBee protocol uses an IP Address (Internet Protocol Address). A tag may hold data in its own memory (instead or in addition to having data stored on a server). Some tags have as much as 5 kB of memory sufficient to record and store basic sensor data. RuBee functions successfully in harsh environments, with networks of many thousands of tags, and has a range of 1 to 30 m (3 to 100 ft) depending on the antenna configuration. By ‘harsh environment’ we mean situations in which one or both ends of the communication are near steel, cement, common building materials or even water. RuBee radio tags function in environments where other radio tags and RFID may have problems. RuBee networks are in use in many visibility applications, including exit-entry detection in high-security government facilities, weapons and small arms in high-security armories, mission-critical specialized tools, smart shelves and racks for high-value assets; and smart entry/exit portals. RuBee radio tags are cyber secure/encrypted.

Without loss of generality the present disclosure will be described in the context of a mobile unit of soldiers operating to perform a specific mission in an urban environment in which the levels of consumable resources including ammunition, battery power and water are monitored and resupplied locally from within the unit and globally from a depot. More generally, an entity could be a human person, a machine such as a robot or weapon system or a combination thereof.

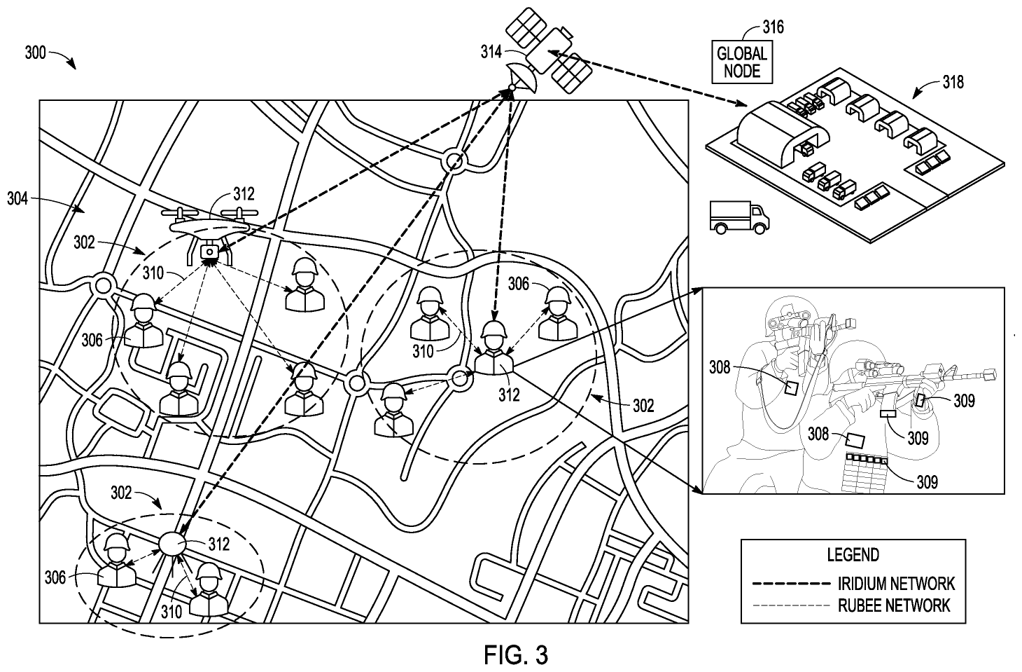

Referring now to FIG. 3, a system 300 is configured to autonomously manage resupply of consumable resources e.g., ammunition, batteries and water for mobile units 302 operating in a harsh or hostile urban environment 304. Soldiers 306 within the mobile unit are provided with tags 308 having a short-range low-bandwidth magnetic communications links such as RuBee (30 KHz-900 KHz) and sensors 309 that monitor a level of a consumable resource. The sensors 309 may be wearable or attached to the resource itself. The sensors 309 may be hardwired to the associated tag 308 or communicate wireless such as via the magnetic communications link. A network 310 of wearable tags 308 communicates via the magnetic communications link. The network 310 communicates with a local node 312 provides both a magnetic communications link to communicate with the network and a long-range high-bandwidth RF communication link (30 MHz to 30 GHz) such as an Iridium network to communicate, here via satellite 314, with a global node 316. Both of RF and magnetic links are bi-directional wireless links. Together the computer processing resources allocated among network of tags 308, local node 312 and global node 316 initiate a local resupply of the consumable resource to one or more soldiers from other soldiers within the mobile unit and a global resupply of the mobile unit from one or more depots 318. The local and global resupply efforts may occur one or more times and at different points to execute a mission. The network 310 of sensors/tags automates the task of monitoring resource levels and managing resupply. The use of the magnetic portion of the EM spectrum (30 KHz to 900 KHz including VSF (FM band), USF (mobile phones), SHF (satellite phones)) for local communications within the mobile unit overcomes the issues presented by the harsh or hostile environments.

The system 300 is provided with an initial load out representative of the mission at hand (e.g., the level of consumable resources provided each entity) that is programmed into each tag 308, into the global node 316 and the global resupply plan at the depot 318 based on the composition of the mobile unit, the mission, the history of resupply requirements of similar units and missions and other factors. This information forms a mission-based baseline. The global resupply plan is updated as resources are consumed and resupplied, and if connection is lost to the local node, the system continues global resupply according to the last updated global resupply plan. The global node is responsive and adjusts to reported levels of consumable resources for each entity within the mobile unit and the unit as a whole, reported health data for each entity and the unit as a whole as well as other situational awareness inputs including but not limited to location information regarding the unit and individual entities, environmental conditions, progress of the mission, changes to the mission and changes to the threat.

Each tag's computer processing resources are configured to condition data from the one or more sensors 309 (to reduce the amount of data to be communicated) and to periodically transmit the level of the consumable resource and to, as warranted, transmit a resupply request. Each tag 308 communicates with the soldier, for example, via a heads up display, to supply messages related to the local or global resupply of the consumable resources of the entity or mobile unit e.g., “request for additional ammo sent”, “request for additional ammo confirmed”, “move to coordinates x,y to receive additional ammo” and the like. Each tag 308 is configured to update the level of the consumable resource upon the completion of the local or global resupply. For example, each consumable resource may be provided with a tag including a magnetic communications link. The presence or absence of a consumable resource proximate the entity's tag updates the level of the consumable resource. If soldier 306, and the soldier's tag 308, wanders out-of-range of the network 310, the tag 310 provides an out-of-range message to the entity. This may alert the soldier they won't be automatically resupplied, prompt the soldier to move back into network, or, in some cases, cause the tag 310 to become a local 312 to communicate directly with other available local nodes 312 or the global node 316.

The local node 312 may be a fixed node that is positioned with the mobile unit but separate from any specific entity. The separation provides a level of safety from targeting when the node transmits via the RF communications link to the node. The local node may be a mobile drone that positions itself, periodically or constantly, within the mobile unit to improve communication among the tags 308 in the network 310. A designated soldier may be provided with a tag that has additional resources (e.g., the RF comm link) to provide the local node. Each tag 308 may include the RF comm link making it capable of being the local node. The network may assign different tags, randomly or according to a pattern, to act as the local node at different times making it harder to detect and locate the local node. One or more tags may not include but may be able to access a long-range high-bandwidth RF communications link within the mobile unit to act as the local node. For example, each soldier may have such an RF comm link for audio/video communications. Alternately, each entity may only have the local RF communications link but which provides access to the long-range high-bandwidth RF communications link. The separation of and combination of magnetic and on-demand RF technologies can greatly increase total system performance while maintaining secrecy and safety.

A visual queue system provides red or green or yellow lights on the soldier's electronic arm band, heads up display or the tag itself corresponding to consumable levels of a resource is optionally added to the system. The soldiers are provided with a visual cue of their own levels of consumable resources and the consumable resource levels of other unit members on demand or when critical resupply is needed.

The soldiers may also be provided with wearable sensors 309 configured to measure health related data. The computer resources allocated among the tags, the local node and the global node monitor the health data to initiate local assistance one or more distressed entities from within the mobile unit and global assistance from an external source. The entities and health related data may be for either humans or machines. In a specific example, the sensor measures a shock level indicative of concussive effects.

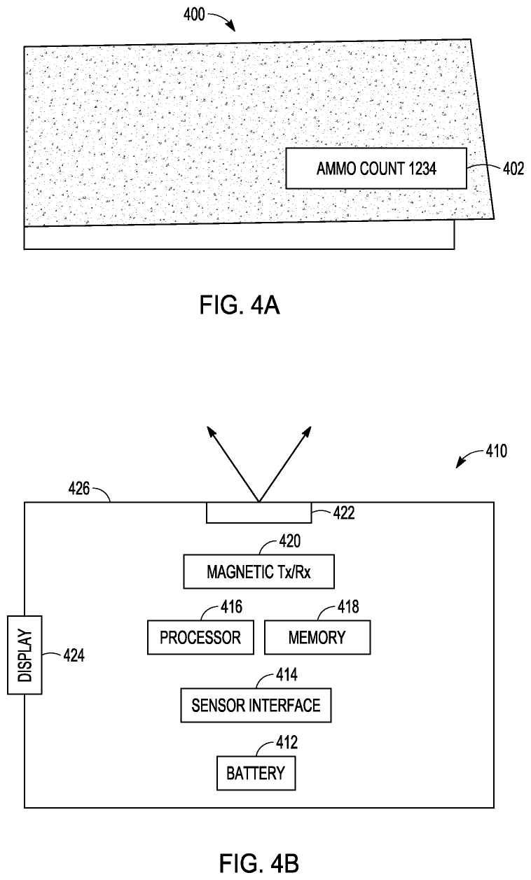

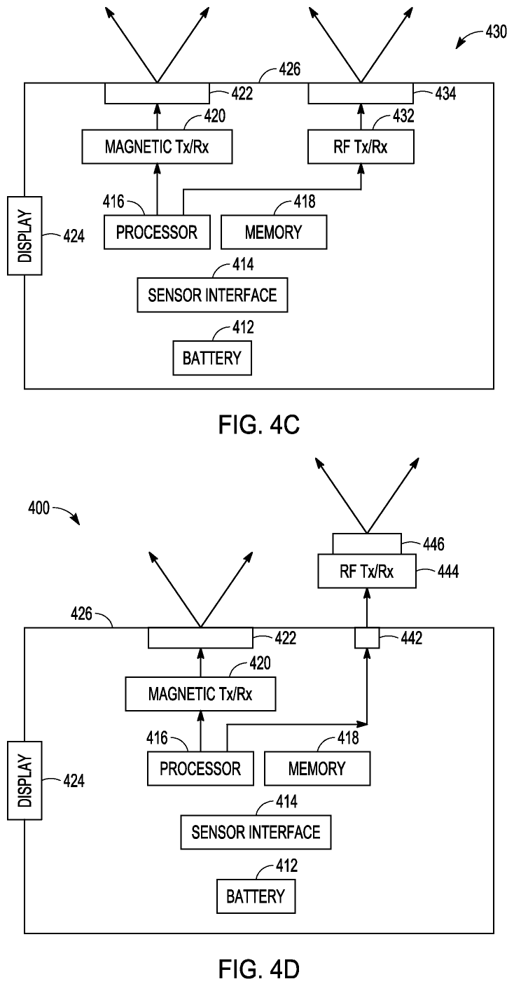

Referring now to FIGS. 4A-4D, a tag 400 is typically about 3 inches long, 1 inch wide and 1 inch thick which includes a small built-in antenna. This configuration typically transmits from zero to 30 feet. The tag utilizes magnetic wavelength signals to send and receive short data. A larger built in or separate magnetic antenna about 3 inches long×¼ inch diameter allows tag 400 to operate in a range of 10 feet to about 100 feet. With larger antennas and a bit more power the range can be extended to about 300 feet. Tag 400 may be provided with a display 402 to display levels of consumable resources or other messages. Tag 400 may include an interface to receive input data.

As shown in FIG. 4B, a tag 410 a battery 412, a sensor interface 414 to receive inputs from various sensors coupled to consumable resources, a computer processor 416 for conditioning sensor data and processing sent and received cyber safe messages, memory 418, a magnetic Tx/Rx 420 to send and receive long wavelength signals, a long wavelength antenna 422, an optional display 424 in a package 426. This instantiation of the tag is only capable of communicating using the magnetic communications link with other tags in the network and the local node.

As shown in FIG. 4C, a tag 430 is configured for both local communications within the network and to act as the local node for communications with the global node. In addition to the components depicted in FIG. 4B, tag 430 further includes an RF Tx/Rx 432 to send and receive short wavelength signals in the RF band via an RF antenna 434. In this scenario, a particular soldier could be provided with tag 430 with the enhanced RF communications capabilities to act as the local node or to act as the local node if a fixed position local node fails. Alternatively, if each soldier is provided with a tag 430, each soldier could serve as the local node providing redundancy and resiliency from detection. Furthermore, if a soldier became disconnected from the network, tag 430 could act as the local node.

As shown in FIG. 4D, a tag 440 is configured for both local communications within the network and to act as the local node for communications with the global node by leveraging existing RF resources already carried by the soldier such as for audio/video communications within the unit or with the global node. In this case, the local node messaging is routed via a port 442 to an external RF Tx/Rx 444 and RF antenna 446.

In a mobile unit, the network of tags is preferably an automatic, self-organizing, self-repairing network that adapts as the unit moves and the soldiers (entities) within the unit move relative to one another to maintain communications among the soldiers, with the local node and to the global node. As the mission is prosecuted, individual soldiers may temporarily move out of range of the network, the network might split into multiple networks, may merge back together. Communications with individual soldiers may be permanently lost. In a self-repairing network, the network is not ‘dependent’ on any one tag. If a tag is missing it simply looks for the next nearest tag but does not stop working. The network is ‘tolerant’ of a missing tag. If the network splits into multiple networks, the system may affect a quasi-local resupply between networks. In certain network configurations, the global node may send messages to probe the network for information regarding levels of consumable resources, health information or other information at the local node or any specific tag.

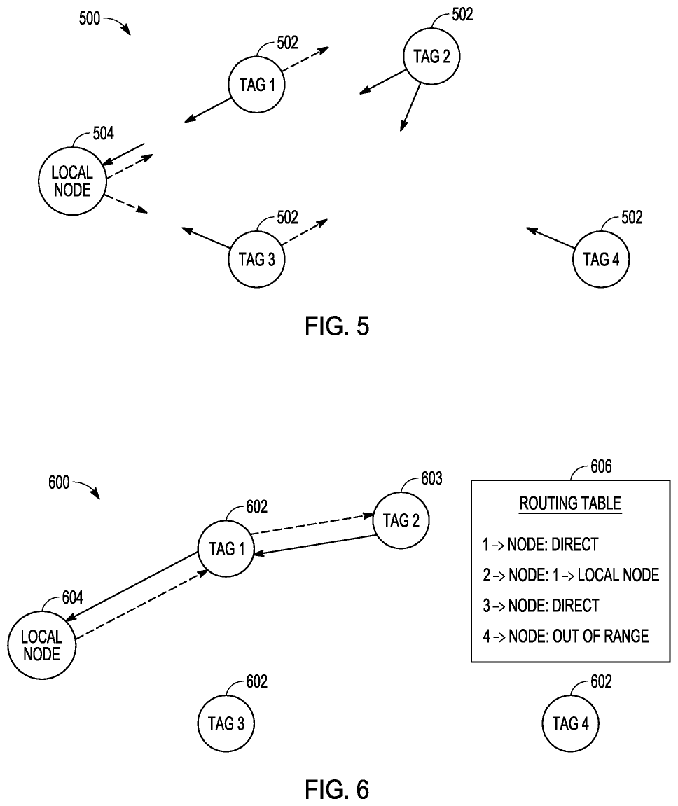

As shown in FIG. 5, a network 500 connecting multiple tags 502 and a local node 504 uses an open topology in which if a tag wishes to communicate with the local node or vice-versa the tag transmits a message via the magnetic communications link. If local node is within range and receives the message directly, the local node transmits a confirmation message. If not, one or more tags receive the message and rebroadcast the message until it reaches the local node, which transmits the confirmation message back through the network. In this example, Tag 4 is out of range and cannot communicate with the network. This may be ascertained by Tag 4 transmitting a message and not receiving a confirmation or simply by inference if the tag doesn't receive any message communications for a specified period of time. This is a brute force approach that is applicable where the tags are moving relative to each other and doesn't require any knowledge of the current topology of the tags.

As shown in FIG. 6, a network 600 connecting multiple tags 602 and a local node 604 uses a defined topology in which a routing table 606 is constantly updated to reflect the most efficient path through the network from any tag to the local node, or between any two tags. If a tag wishes to communicate with the local node or vice-versa the tag transmits a message via the magnetic communications link according to the routing table.

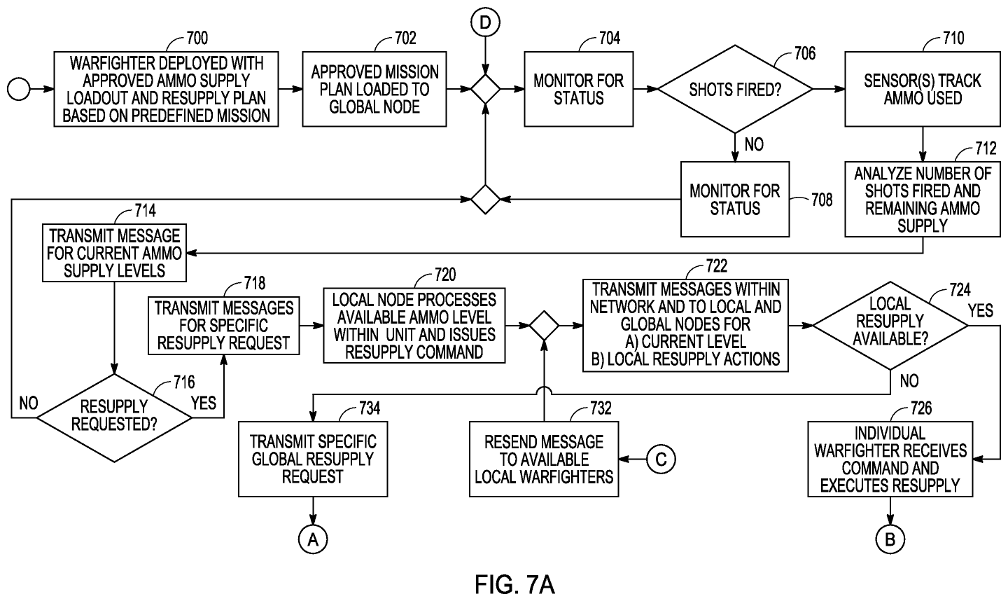

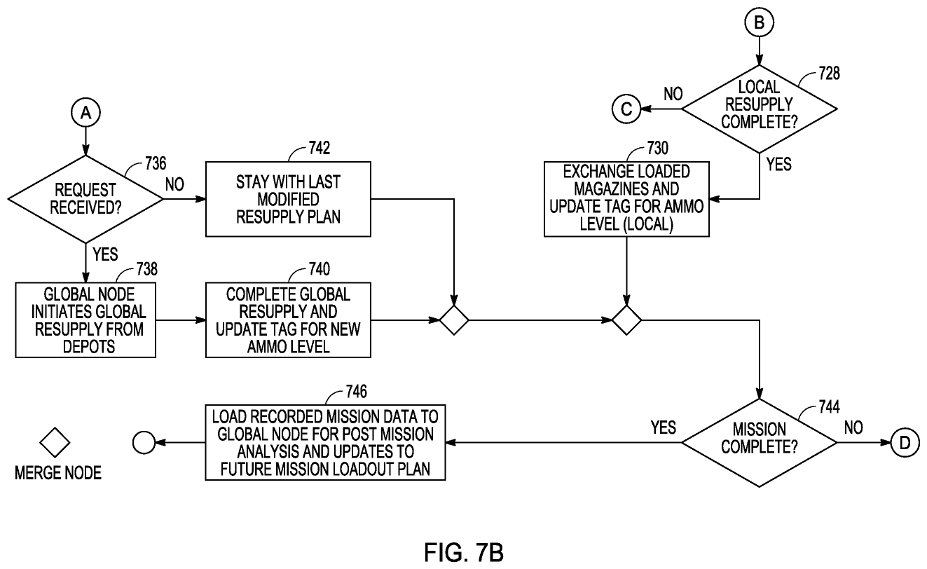

Referring now to FIGS. 7A-7B, in an embodiment for monitoring and initiating local and global resupply of ammunition to a mobile unit of warfighters, the warfighters are deployed with an approved ammo supply loadout and resupply plan based on a predefined mission (step 700). This information is loaded into each of the tags, the local node and the global node (step 702). Each tag monitors the shot sensor for status of shots taken (steps 704 and 708). If a shot is fired, and sensed, (step 706), the sensor tracks the ammo used (step 710) and the tag analyzes the number of shots fired and a remaining ammo supply (step 712). The tag transmits messages for current ammo supply levels to the local node (step 714).

The local node aggregates the current ammo supply levels for each tag to determine if resupply is required (step 716). Alternately or in addition to, the tag may transmit a message for a specific ammo resupply request (step 718). The local hub process available ammo levels within the unit and issues resupply commands both to the soldiers needing or requesting resupply and the soldiers that will provide the resupply (step 720). The local hub transmits messages for current ammo levels and local resupply actions to the associated tags (step 722). The local hub suitably transmits these ammo levels an actions to the global node so that it is aware of local conditions and can appropriate update its global resupply plan.

The network determines whether the local resupply is available (step 724). If yes, the individual warfighter receives the command and executes the resupply (step 726). The network determines if the local resupply is complete (step 728). If yes, the warfighters exchange the magazines and both the providing and the receiving warfighters' tags are updated for ammo level (step 730). If no, the local node resends the local resupply message to other available local warfighters with sufficient ammo levels to perform the resupply (step 732).

If local resupply is not available in step 724, the local node transmits a specific global resupply request to modify and expedite global resupply of the mobile unit (step 734). If the global node receives the request at step 736, the global node initiates global resupply from one or more depots via drone, truck or other method of resupply. Once the global resupply is completed, the tags, local node and global resupply plane are updated to reflect the replenished ammo levels (step 740).

The loop continues to monitor the levels of ammunition for individual warfighters and the mobile unit and to initiate local and global resupply of ammunition as needed or requested until the mission is complete (step 744). Recorded mission data is loaded to the global node for post mission analysis and updates to future mission loadout plans (step 746).

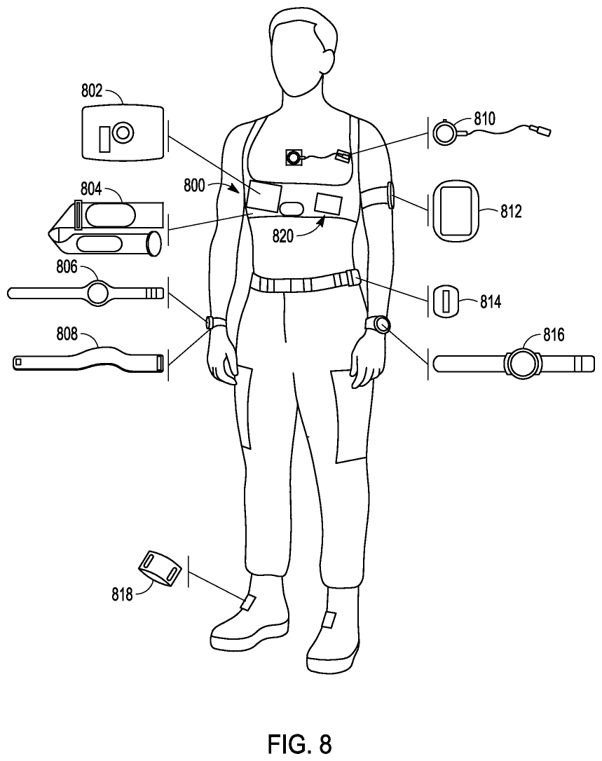

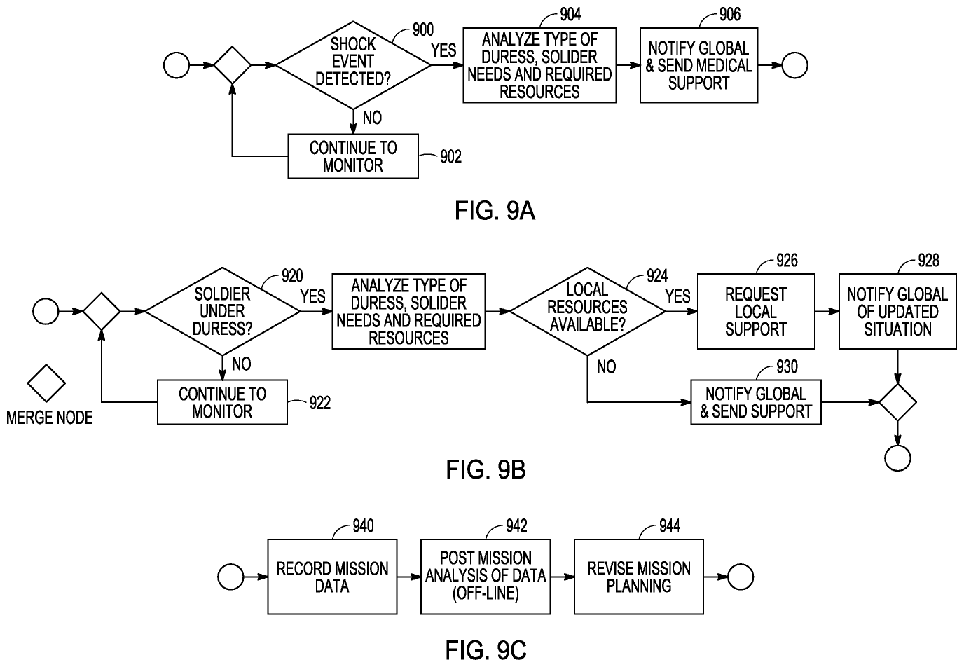

Referring now to FIGS. 8 and 9, the same system can be adapted to monitor health data of the individual warfighters and of the mobile unit as a whole to initiate local assistance to one or more distressed warfighters from within the mobile unit and to initial global assistance from external sources. The warfighter is provided with a tag 800 that receives health data from one or more health sensors. For example, Equivital's Hidalgo EQ02 sensor 802 monitors physiological and vital signs, Wahoo's TICKR X sensor 804 measures heart rate, a Activinsights' GENEActive sensor 806 measures acceleration, a Mio FUSE sensor 808 measures heart rate and sleep activity, CamNtech's ActiHeart sensor 810 measures ECG, Biofourmis' Everion sensor 812 measures heart rate, blood oxygen levels, skin temp, skin blood profusion and physical activity, Axiamo's Axiamote PADIS 2.0 sensor 814 measures long term activity, Garmin's Fenix 3 sensor 816 measures GPS fitness and Vicon's BlueThunder sensor 818 measures athletic tracking and sports performance. The warfighter may also be fitted with a wearable pressure sensor 820 such as ENDEVCO's 8515C, IFM's P/N 7294 or STI's Bastille device to detect a shock event as an indicator of concussive effects. The tag's processor conditions the data to monitor and store locally data for later processing and to send messages pertinent to distress of the warfighter that may trigger or specifically request local or global assistance of the warfighter.

As shown in FIG. 9A, a pressure sensor detects whether a shock event has occur (step 900). If no, the sensor continues to monitor (step 902). If yes, the individual tag, and possibly the local node, analyzes the type of duress (e.g., concussive effect), soldier needs and required resources (step 904) and via the local node sends a message to the global node to send medical support from an external source (step 906).

As shown in FIG. 9B, a pressure sensor detects whether a shock event has occur (step 920). If no, the sensor continues to monitor (step 922). If yes, the individual tag, and possibly the local node, analyzes the type of duress (e.g., concussive effect), soldier needs and required resources (step 924) and determines if resources are available within the unit (step 926). If yes, the tag or local node sends a request to other warfighters in the unit to provide local support (step 928) and notifies the global node of the updated situation (step 930). If no, the local node sends a message to the global node to send medical support from an external source (step 932).

As shown in FIG. 9C, the tag, and possibly the local node, records mission health data (step 940), the health data is downloaded and analyzed off-line after the mission (step 942) and the loadout and global resupply plans are revised accordingly (step 944).

While several illustrative embodiments of the disclosure have been shown and described, numerous variations and alternate embodiments will occur to those skilled in the art. Such variations and alternate embodiments are contemplated, and can be made without departing from the spirit and scope of the disclosure as defined in the appended claims.

We claim:

1. A system for managing resupply of consumable resources for a mobile unit, the system comprising:
one or more depots for storing a consumable resource;
a global node including computer processing resources and a high-speed bi-directional RF communications link;
a plurality of wearable tags for different entities in a mobile unit, each tag including a sensor communication interface, computer processing resources, and a magnetic communications link;
one or more sensors associated with each wearable tag, said one or more sensors configured to monitor a level of the consumable resource associated with the entity and to communicate the level of the consumable resource to the tag's communication interface;
a local node including computer processing resources, an RF communications link to communicate with the global node and a magnetic communications link; and
a network of the plurality of wearable tags and the local node to communicate within the mobile unit using the magnetic communications links;
wherein the computer processing resources allocated among the tags, the local node and the global node monitor the levels of the consumable resources of different entities to initiate a local resupply of the consumable resource to one or more entities from other entities within the mobile unit and a global resupply of the mobile unit from the one or more depots.

2. The system of claim 1, wherein each said tag and the global processing unit are programmed with an initial resource level, wherein the global node is configured to initiate global resupply according to a global resupply plan for a specified mission, to update the global resupply plan as resources are consumed and resupplied, and if connection is lost to the local node to continue global resupply according to the last updated global resupply plan.

3. The system of claim 2, wherein the global node is responsive to levels of consumable resources for the mobile unit and situational awareness inputs including at least a plurality of location information regarding the unit and individual entities, environmental conditions, progress of the mission, changes to the mission and changes to the threat.

4. The system of claim 1, wherein each tag's computer processing resources are configured to condition data from the one or more sensors and to periodically transmit the level of the consumable resource and to, as warranted, transmit a resupply request.

5. The system of claim 1, wherein each tag communicates with the entity to supply messages related to the local or global resupply of the consumable resources of the entity or mobile unit.

6. The system of claim 1, wherein the tags are configured to update the level of the consumable resource upon the completion of the local or global resupply.

7. The system of claim 6, wherein each consumable resource is provided with a magnetic communications link, wherein the presence or absence of a consumable resource updates the level of the consumable resource in the tag.

8. The system of claim 1, wherein if the tag is out-of-range of the network the tag is configured to supply an out-of-range message to the entity.

9. The system of claim 8, wherein if the tag is out-of-range or stops transmission for a specified period of time, the global node initiates resupply based on a preloaded mission-based loadout and projected consumption of the mobile unit.

10. The system of claim 1, wherein the local node is separate from and fixed relative to the mobile unit.

11. The system of claim 1, wherein the local node is a mobile drone that repositions itself within the mobile unit to improve communication among the tags in the network.

12. The system of claim 1, wherein each tag includes an RF communications link, wherein one of the tags acts as the local node.

13. The system of claim 12, wherein the network is configured to assign different tags to act as the local node at different times.

14. The system of claim 1, wherein one or more entities in the mobile unit has an RF communications link, wherein at least one tag can access the RF communications link to act as the local node.

15. The system of claim 14, wherein each entity includes a low-power bi-directional RF communications link to communicate within the unit and one or more entities include the RF communications link to communicate with the global node.

16. The system of claim 1, wherein the RF communications link operates in a frequency range of 30 MHz to 30 GHz and the magnetic communications link operates in a frequency range of 30-900 KHz.

17. The system of claim 1, wherein the entity is a human person, wherein the tag generates a visible cue to alert the person and other persons in the mobile unit as to a criticality of a consumable resource.

18. The system of claim 1, further comprising one or more wearable sensors coupled to the entity to measure health related data, wherein the computer processing resources allocated among the tags, the local node and the global node monitor the health data to initiate local assistance to one or more distressed entities from within the mobile unit and global assistance from an external source.

19. The system of claim 18, wherein the entity is a human person, wherein one of the wearable sensors is configured to measure shock levels indicative of concussive effects.

20. A system for managing resupply of ammunition for a mobile unit of warfighters, the system comprising:
one or more depots for storing ammunition;
a global node including computer processing resources and an RF communications link;
a plurality of wearable tags for different warfighters in the mobile unit, each tag including a sensor communication interface, computer processing resources, a magnetic communications link and a display for displaying an ammunition level, each said tag being programmed with an initial ammunition level;
a gun shot detection sensor associated with each wearable tag and weapon, said gun shot detection sensor configured to detect gun shots associated with the warfighter's weapon and to communicate each gun shot to the tag's communication interface, each said tag responsive to a gun shot to reduce the ammunition level;
a local node including computer processing resources, a high-speed bi-directional RF communications link to communicate with the global node and a low-speed bi-directional magnetic wireless communications link; and
a network of the plurality of wearable tags and the local node to communicate within the mobile unit using the low-speed bi-directional magnetic wireless communications link;
wherein the computer processing resources allocated among the tags, the local node and the global node monitor the warfighters' ammunition levels to initiate a local resupply of ammunition to one or more warfighters from other warfighters within the mobile unit and a global resupply of ammunition to the mobile unit from the one or more depots.
